(19) United States
(12) Patent Application Publication
(10) Pub. No.: US 2025/0342207 A1
(43) Pub. Date: Nov. 6, 2025

(54) Record Linkage and Entity Resolution

(71) Applicant: University of Connecticut, Farmington, CT (US)

(72) Inventor: Sanguthevar Rajasekaran, Ellington, CT (US)

(73) Assignee: University of Connecticut, Farmington, CT (US)

(21) Appl. No.: 19/196,295

(22) Filed: May 1, 2025

Related U.S. Application Data
(60) Provisional application No. 63/640,900, filed on May 1, 2024.

(51) Int. Cl. G06F 16/901; G06F 16/906

(52) U.S. Cl. CPC G06F 16/9024; G06F 16/906

(57) ABSTRACT

Methods and apparatuses are described herein for sorting with diverse sets of data. The methods and apparatuses receive a plurality of records from one or more data sources, create superblocks based upon one or more blocking attributes, generate k-mers for all the records based upon a selected k value, perform blocking on the records and place any records with matching k-mers in the appropriate superblocks, define a graph G(V, E) where there is a node per record and connect records via an edge in the graph when the records are found together in at least one of the superblocks and an edit distance between the records is within a given threshold value, and find and output the connected components of graph G(V, E) as final clusters.

### CROSS-REFERENCE TO RELATED APPLICATION

This application claims the benefit of priority to U.S. Provisional Application Ser. No. 63/640,900, filed on May 1, 2024, and entitled Record Linkage and Entity Resolution, the entire disclosures of which are expressly incorporated by reference herein.

### STATEMENT REGARDING FEDERALLY SPONSORED RESEARCH

This invention was made with government support under grant number CB21RMD0160003 awarded by the US Census Bureau. The government has certain rights in the invention.

### BACKGROUND

The present disclosure herein relates to techniques for sorting and linking data with diverse sets of data.

Efficient and accurate record linkage and entity resolution are of immense interest across many sectors, including government, health, public safety, and national security. Given a collection of records, a technique for resolving problems of record linkage and entity resolution is to cluster the records, such that each cluster includes records belonging to one and only one entity. Examples of an entity include an individual, a family, a business, etc. If all the records pertaining to the same entity are exactly identical, with no errors in any of the (primary) attributes, the problem of record linkage is straightforward. In such instances, solve and database JOIN algorithms can be used to connect related records. Unfortunately, records of the same person might look different owing to errors introduced by typing, phonetic similarity, differences in data collection, missing data, etc. Challenges persist, then, with record linkage and entity resolution methods that integrate records across different data sources usually in the absence of any global identifier and with many sources of error. Chief among these challenges are long run times, poor accuracy, restrictions in applicability, and lack of parallel solutions.

Thus, there is a need for methods and apparatuses that provide techniques for record linkage that are fast, accurate, and tolerant of diverse data.

### SUMMARY

According to one aspect of the disclosure, a computer implemented method for sorting diverse sets of data is provided. The method includes receiving a plurality of records from one or more data sources, wherein each record includes one or more attributes associated with an entity. Superblocks are created based upon one or more blocking attributes. k-mers are generated for all the records based upon a selected k value. Blocking is performed on the records and placing any records with matching k-mers in the appropriate superblocks. A graph G(V, E) is defined where there is a node per record and connecting records via an edge in the graph when records are found together in at least one of the superblocks and an edit distance between the records is within a given threshold value. The connected components of graph G(V, E) are found and outputted as final clusters.

### BRIEF DESCRIPTION OF THE DRAWINGS

The features and advantages of the present disclosure are apparent from the following description taken in conjunction with the accompanying drawings in which:

FIG. 1 is a schematic diagram depicting aspects of an exemplary information handling system, according to some embodiments.

FIG. 2 is a flow chart providing an exemplary process for implementing steps of the techniques disclosed herein, according to some embodiments.

FIG. 3 is a flow chart illustrating an exemplary method for superblocking, according to some embodiments.

FIG. 4 presents experimental results demonstrating the performance of superblocking record linkage and entity resolution on synthetic data that is more challenging than real datasets from the Connecticut Health Information Network.

### DETAILED DESCRIPTION

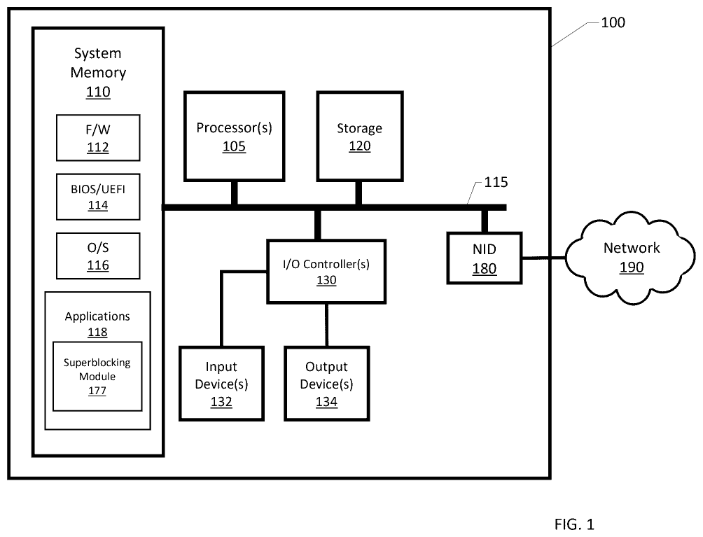

Disclosed herein are methods and apparatuses for record linkage and entity resolution with diverse sets of data. Blocking algorithms divide records into smaller groups using common features so that only records within the same block are compared. According to some embodiments, blocking algorithms may be combined with advanced superblocking models (e.g., superblocking module 177 as depicted in FIG. 1). Superblocking module 177 can be implemented on any sequential and/or parallel computer architectures. According to some embodiments, the methods and apparatuses described herein provide a practical application of record linkage and entity resolution with diverse sets of data. According to some embodiments, the methods and apparatuses described herein address the technical problem of long run times, poor accuracy, restrictions in applicability, and lack of parallel solutions associated with existing blocking algorithms. In one or more embodiments, superblocking module 177 improves computer performance by outperforming existing blocking algorithms in terms of runtimes and accuracy. In one or more embodiments, superblocking module 177 provides a technical solution for record linkage and entity resolution with diverse sets of data and is about ten to twenty times faster than traditional blocking techniques.

A block search algorithm is a type of search algorithm used to find a single solution within a large search space. It works by dividing the search space into blocks and searching each block in turn. The algorithm is designed to work efficiently even when the search space is very large and the solution is difficult to find. In a block search algorithm, the search space is divided into blocks based on some predefined criteria. For example, the blocks could be defined based on the value of some parameter, or based on some other characteristic of the problem being solved. Each block is then searched independently for a solution.

The advantage of a block search algorithm is that it can be much faster than searching the entire search space. By dividing the search space into blocks, a block search algorithm can focus its search on the most promising areas, and avoid searching areas that are unlikely to contain a solution. This can save a significant amount of time and computing resources. Block search algorithms are used in a variety of applications, including computer vision, natural language processing, and machine learning. They are particularly useful when the search space is large and complex, and the solution is difficult to find using traditional search algorithms.

In numerical linear algebra, a block algorithm organizes a computation so that it works on contiguous chunks of data. A blocked algorithm and the corresponding unblocked algorithm (with blocks of size 1) are mathematically equivalent, but the blocked algorithm is generally more efficient on modern computers.

A high-level description of a typical record linkage algorithms follows. 1. Problem: Given a set of records, identify identical clusters and select only a representative per cluster. Further processing is only on these representatives. 2. Perform blocking on the records. Records are placed in blocks. A record might be in multiple blocks. 3. Define a graph G (V, E) where there is a node per record. There is an edge between two nodes if records are found together in at least one of the blocks and if the distance between the records is within a given threshold. Find and output the connected components of G(V, E) as final clusters.

In one or more embodiments, superblocking module 177 employs k-mers. For example: Let R be a record. In one or more embodiments, each record R is considered as a string of characters. In one or more embodiments, for some relevant k, all the k-mers of R are generated. In one or more embodiments, there will be a total of sk blocks, where sis the size of the alphabet. In one or more embodiments, R will be placed in the blocks corresponding to all the k-mers in it. In one or more embodiments, when the alphabet size is s and k-mer based blocking is employed, the number of blocks will be sk. In one or more embodiments, the set of these blocks is referred to as a superblock. In one or more embodiments, blocking is done with respect to one or more of the attributes (such as last name, first name, etc.). In one or more embodiments, the collection of these attributes is referred to as a blocking attribute. Embodiments disclosed herein provide advantages in having a superblock for every starting character of the blocking attribute.

Consider a data set having records with the following blocking attributes: K annan, Cannan, Johnson, Jackson, Krista, Crista, Mekia, Mekima, Becca, Annan, Crystal. In this example, superblocks are included for: A, B, C, J, K, and M. These records will be included in the following superblocks:

| Superblock | Attributes/Content |
|---|---|
| A | Annan |
| B | Becca |
| C | Crista, Cannan, Crystal |
| J | Johnson, Jackson |
| K | Krista, Kannan |
| M | Mekia, M ekima |

In one or more embodiments, within every superblock there will be at most s^{k} nonempty blocks. For example, assume that k=3. Johnson and Jackson will share a block (“son”) in superblock J. Crista and Crystal will share a common block (“sta”) in superblock C. Even though Annan and Cannan share a 3-mer (“nna”), they will not share a block since the records do not start with the same letter. Also, Crystal and Krista will not share a block even though they share a 3-mer (“sta”) for the same reason. If the superblocks are processed with conventional blocking algorithms, the above links will be missed.

In one or more embodiments, if the first character in the blocking attribute is equally likely to be any character of the alphabet, then the sizes of the superblocks will be expected to be the same. Let nbe the number of records. In one or more embodiments, the expected number of records in each superblock is n/s. Wherein n is the number of records and sis the alphabet size. In one or more embodiments, the expected time to do record linkage with q records is O(q^{1+ϵ}) for some 1>ϵ>0. In one or more embodiments, the expected linkage times using the standard and the novel superblocking schemes will be O(n^{1+ϵ}) and O(n^{1+ϵ}/S^{ϵ}), respectively. In one or more embodiments, if the probability of an error in the first character of the blocking attribute is small, then the F1 score will be good. As used herein, an F1 score is a measure of predictive performance that measures a model's accuracy based on precision and recall scores of a model.

Consider the case of at most a single error in the blocking attribute. More specifically, consider the case of an edit distance of ≤1 in the blocking attribute. In one or more embodiments, for any two records that belong to the same entity, the edit distance between these records in the blocking attribute is no more than 1. In one or more embodiments, record linkage can be completed without any sacrifice in the F1 score. In this example, the superblocking idea can be employed as before. As used herein, the “edit distance” between two strings is the minimum number of operations used to transform one string into the other.

Consider two records R₁ and R₂, which may either belong to the same entity or different entities. Let their blocking attributes be B₁ and B₂. In one or more embodiments, if R₁ and R₂ belong to different entities, then superblocking module 177 will not link them if the standard blocking does not link them. Also, in one or more embodiments, the memory used with superblocking module 177 is the same as the memory used without superblocking. In one or more embodiments, the total number of records in all of the blocks together will be n(L−ₖ+1), where L is the length of the blocking attribute of each record.

Consider the case where the distance between two records is no more than one in the blocking attribute. There are two options to consider:

In the first option, the edit distance between B₁ and B₂ is zero. In some embodiments, superblocking module 177 will handle these two records in the same way as standard blocking. In the second option, the edit distance between B₁ and B₂ is 1. Here, there are three possibilities:
(i) The first characters of B₁ and B₂ are the same. An example: Johnson and Johnsan. In this case, both R₁ and R₂ will belong to the same superblock and hence will be processed in the same manner as in standard blocking.
(ii) The first characters are different. An example: K annan and Cannan.
(iii) The first character is missing either in R₁ or R₂. An example: Elizabeth and Lizabeth.

In one or more embodiments, to handle cases (ii) and (iii) (in the same manner as in standard blocking), the following algorithm can be used. First, let B=B₁, B₂, . . . , Bₙ be the blocking fields of all the input records. Let B′i be the same as Bᵢ except that the first letter has been deleted, for 1≤i≤n. Let B′=B′₁, B′₂, . . . , B′ₙ. For instance, if B=Elizabeth, Kannan, Johnson, Krista, Crista, Cannan, Annan, then, B′=Lizabeth, Annan, Ohnson, Rista, Rista, Annan, Nnan. In one or more embodiments, B and B′ are then concatenated to get X and sort X lexicographically. Keep the record ID for each entry in X. In one or more embodiments, the sorted X will be the following:

| Blocking attribute/ | |
|---|---|
| Content | Record ID |
| Annan | 7 |
| Annan | 2 |
| Annan | 6 |
| Cannan | 6 |
| Crista | 5 |
| Elizabeth | 1 |
| Johnson | 3 |
| Kannan | 2 |
| Krista | 4 |
| Lizabeth | 1 |
| Nnan | 7 |
| Ohnson | 3 |
| Rista | 4 |
| Rista | 5 |

In one or more embodiments, sorted X brings together records that could possibly belong to the same entity. For example, Krista and Crista have been brought together. A s another example, Kannan, Cannan, and Annan have been brought together. In one or more embodiments, after sorting X, clusters based on identity are formed. For example, Annan (7), Annan (2), and Annan (6) will form a cluster; Cannan (6) will form a cluster; and Rista (4) and Rista (5) will form a cluster.

For every pair of entries A and B in C: Let A′ and B′ be the full blocking fields of A and B, respectively. In one or more embodiments, if the first letter of A′≠the first character of B′ then compute the distance between the two associated records. In one or more embodiments, if this distance is ≤ the threshold, insert an edge (e.g. a connection) between these two records in the graph G generated from the superblocking step. In one or more embodiments, find and output the connected components of G.

In one or more embodiments, certain efficiencies have been observed when employing the techniques disclosed herein for superblocking module 177. In one or more embodiments, when the edit distance in the blocking field is ≤1, there is no additional error introduced by superblocking module 177 with the post-processing described above. In one or more embodiments, the F1 score is not different (from standard blocking). In one or more embodiments, the distance in the other fields can be arbitrary. In one or more embodiments, the probability of an error of more than 1 in the blocking field appears to be very low. In one or more embodiments, most cases are covered when the edit distance in the blocking field is ≤1.

Having introduced aspects of superblocking module 177, some additional considerations are introduced.

Consider the general case where the edit distance between two records in the blocking attribute is arbitrary. In one or more embodiments, superblocking module 177 for this case is based on the observation that clusters that are very small in size tend to be erroneous. Keeping this in mind, the following variation is provided.

In one or more embodiments, superblocking can be performed to generate the graph G (V, E). In one or more embodiments, sorting can be performed as a post processing step to take care of the case of edit distance 1 in the blocking field. In one or more embodiments, this will add more edges to G. In one or more embodiments, resultant clusters can be put together for those whose sizes are “small.” In one or more embodiments, the “small” resultant clusters can be incrementally linked to the rest of the clusters. In one or more embodiments, any incremental record linkage algorithm can be employed.

In one or more embodiments, the techniques disclosed herein for superblocking module 177 may be implemented in a myriad of information handling systems.

FIG. 1 is a schematic diagram depicting aspects of an exemplary information handling system, according to some embodiments. FIG. 1 illustrates a block diagram representation of a non-limiting example of an information handling system (IHS) 100, within which one or more of the described features of the various embodiments of the disclosure can be implemented. For purposes of this disclosure, an information handling system, such as IHS 100, may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. In one or more embodiments, an information handling system may be a handheld device, personal computer, a server, a network storage device, or any other suitable device and may vary in size, shape, performance, functionality, and price. In one or more embodiments, the information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. In one or more embodiments, the information handling system may also include one or more buses operable to transmit communications between the various hardware components.

As shown in FIG. 1, IHS 100 includes one or more processor(s) 105 coupled to system memory 110 via system interconnect 115. In one or more embodiments, the one or more processor(s) 105 may also be referred to as a “central processing unit (CPU) 105.” In one or more embodiments, system interconnect 115 can be interchangeably referred to as a “system bus 115.” In one or more embodiments, also coupled to system interconnect 115 is storage 120 within which can be stored one or more software and/or firmware modules and/or data (not specifically shown). In one or more embodiments, storage 120 can be a hard drive or a solid state drive. In one or more embodiments, the one or more software and/or firmware modules within storage 120 can be loaded into system memory 110 during operation of IHS 100. As shown, system memory 110 can include therein a plurality of software and/or firmware modules including firmware (F/W) 112, basic input/output system/unified extensible firmware interface (BIOS/UEFI) 114, operating system (O/S) 116 and application(s) 118 (e.g., superblocking module 177). In one or more embodiments, the various software and/or firmware modules have varying functionality when their corresponding program code is executed by one or more processors 105 or other processing devices within IHS 100. In one or more embodiments, during boot-up or booting operations of IHS 100, processor 105 selectively loads at least BIOS/UEFI driver or image from non-volatile random access memory (NV RAM) to system memory 110 for storage in BIOS/UEFI 114. In one or more embodiments, BIOS/UEFI image comprises the additional functionality associated with unified extensible firmware interface and can include UEFI images and drivers.

In one or more embodiments, IHS 100 further includes one or more input/output (I/O) controllers 130 which support connection by, and processing of signals from, one or more connected input device(s) 132, such as a keyboard, mouse, touch screen, or microphone. In one or more embodiments, I/O controllers 130 also support connection to and forwarding of output signals to one or more connected output device(s) 134, such as a monitor or display device or audio speaker(s).

In one or more embodiments, IHS 100 further includes a network interface device (NID) 180. In one or more embodiments, NID 180 enables IHS 100 to communicate and/or interface with other devices, services, and components that are located external to IHS 100. In one or more embodiments, these devices, services, and components can interface with IHS 100 via an external network, such as exemplary network 190, using one or more communication protocols. In one or more embodiments, a customer provisioned system/platform can comprise multiple devices located across a distributed network, and NID 180 enables IHS 100 to be connected to these other devices. In one or more embodiments, network 190 can be a local area network, wide area network, personal area network, and the like, and the connection to and/or between network and IHS 100 can be wired or wireless or a combination thereof. In one or more embodiments, network 190 is indicated as a single collective component for simplicity. In one or more embodiments, network 190 can include one or more direct connections to other devices as well as a more complex set of interconnections as can exist within a wide area network, such as the Internet.

In one or more embodiments, the IHS 100 includes a plurality of “computing resources.” In one or more embodiments, the computing resources provide system functionality needed for computing functions. In one or more embodiments, exemplary computing resources include, without limitation, processor(s) 105, system memory 110, storage 120, and the input/output controller(s) 130, and other such components.

In one or more embodiments, the techniques disclosed herein may be implemented as a computer program product that includes machine executable instructions stored on non-transitory machine-readable media. In one or more embodiments, the computer program product may be stored as, for example, an application 118. In one or more embodiments, the instructions provide for efficient use of processor 105 in searching data stored in, for example, system memory 110, storage 120, and/or provided as remote data obtained from another source through network 190.

By way of non-limiting examples, superblocking module 177 as enabled by the teachings herein may be used in a variety of applications. In one or more embodiments, superblocking module 177 may be used for census population studies, hospital records, public information searching, forensic data collections, and many more applications.

In one or more embodiments, superblocking module 177 may be used with census population studies. In census data scenarios, the U.S. Census Bureau collects data from different sources (such as social security administration, healthcare providers, traffic data, transactional data, etc.) and analyzes them. One of the outcomes of such analysis is the population statistics that the U.S. Census Bureau releases every ten years. The U.S. Census Bureau employs record linkage to arrive at the population statistics.

With regards to hospital record searching, consider that when a patient arrives at a hospital, the first thing hospital staff typically do is check if there is a record for the patient. This is important since, for example, if there is a record, the hospital staff may realize that certain tests have already been completed and there is no need to repeat such tests. This results in savings of time and money. In fact, hospital staff may also check for records with other healthcare providers to see if the tests have been completed. This entire process is based on record linkage.

With regards to public information searching, of general public interest is a problem where, using the name of a person, one may wish to collect all the publicly available information about the person.

In one or more embodiments, superblocking module 177 can also be used with forensic searching. One of the powerful tools used in forensics is searching biometric data such as DNA, fingerprints and the like. Specimens are often found at crime scenes. The next step is to identify the person to whom the data belongs. There are several databases where biometric data of known persons are stored. These databases can be used to identify the owner of the data.

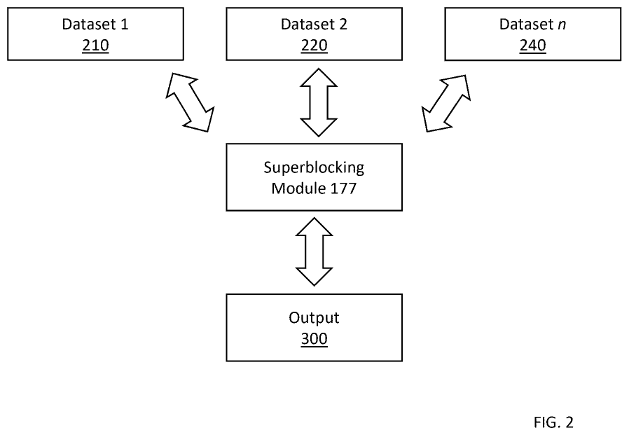

FIG. 2 is a flow chart providing an exemplary process for implementing steps of the techniques disclosed herein, according to some embodiments. Referring to FIG. 2, as shown therein, in some embodiments, the data sets may be diverse. In one or more embodiments, data may be harvested from Dataset 1 210, Dataset 2 220, and other datasets, on up through Dataset-n 240. In one or more embodiments, superblocking module 177 may search and link data according to user input using techniques as set forth herein. In one or more embodiments, the results are provided as output 300.

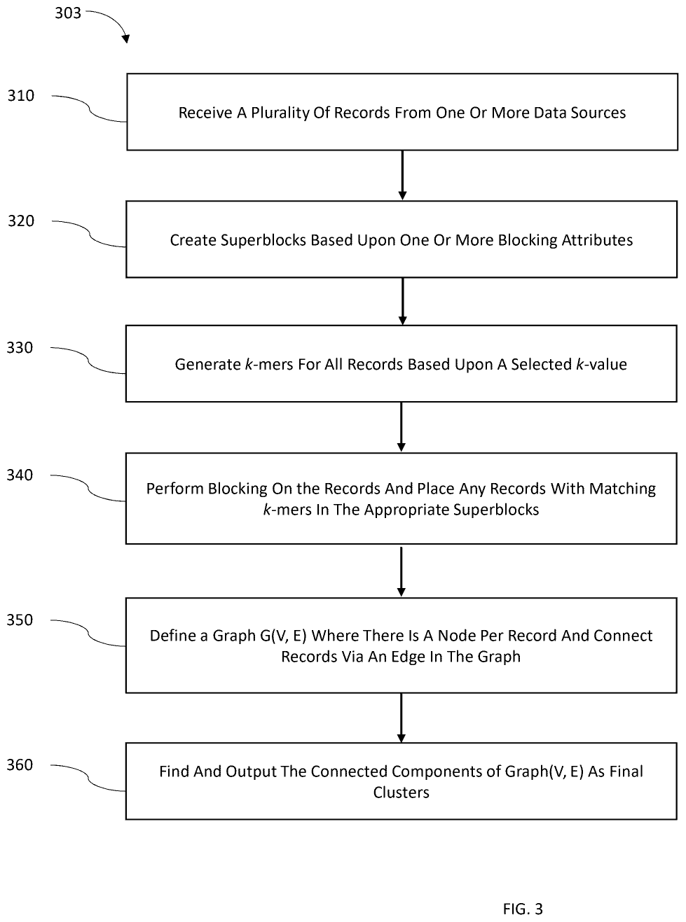

FIG. 3 is a flow chart illustrating an exemplary method for superblocking, according to some embodiments. Method 303 may be performed using one or more modules of information handling system 100 described above. At block 310, the method 303 receives a plurality of records from one or more data sources, wherein each record includes one or more attributes associated with an entity. In one or more embodiments, each record is a string of characters and a record can be in multiple blocks. At block 320, the method 303 creates superblocks based upon one or more blocking attributes. In one or more embodiments, the superblocks can be defined based upon predefined criteria, the value of some parameter, or another characteristic of the problem being solved. At block 330, the method 303 generates k-mers for all the records based upon a selected k-value. At block 340, the method 303 performs blocking on the records and places any records with matching k-mers in the appropriate superblocks. In one or more embodiments, blocking on the records is comprised of a total of sk blocks, where sis the size of the alphabet and k is the selected value for k-mers. In one or more embodiments, blocking on the records can be adjusted to account for the deletion of the first character in a record when determining whether to add records to a superblock. At block 350, the method 303 defines a graph G(V, E) where there is a node per record and connects records via an edge in the graph when they are found together in at least one of the superblocks and an edit distance between the records is within a given threshold value. In one or more embodiments, the edit distance can be adjusted so the edit distance between records in the blocking attributes is no more than a selected value. In one or more embodiments, the threshold value can be calculated using an empirical ground truth error rate for a sample of the records. At block 360, the method 303 finds and outputs the connected components of graph G(V, E) as final clusters.

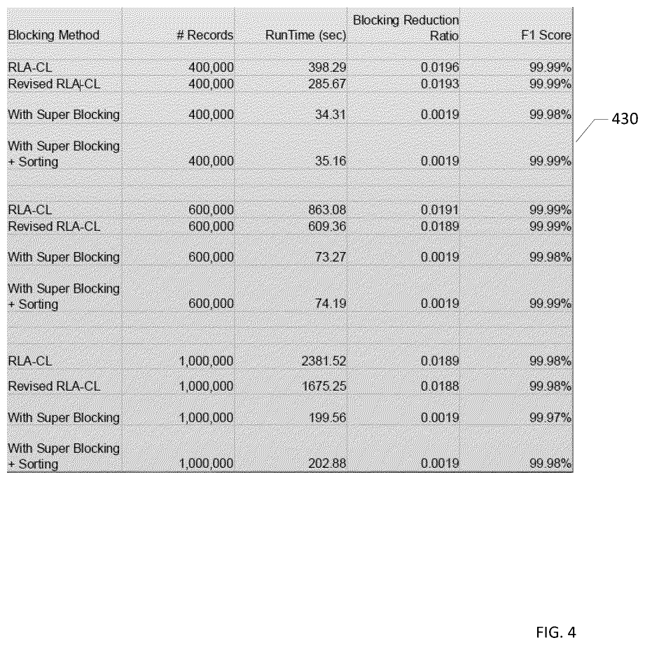

FIG. 4 presents experimental results demonstrating the performance of superblocking record linkage and entity resolution on synthetic data that is more challenging than real datasets from the Connecticut Health Information Network. As shown, experimental results 430 indicate that superblocking improves runtime performance by approximately a factor of 10 compared to conventional approaches without a corresponding loss in accuracy. These results confirm that the described techniques achieve substantial computational efficiency gains while maintaining accuracy levels as indicated by the F1 Score column. Furthermore, experimental results 430 demonstrate that superblocking with sorting can further improve F1 Score results with a minimal increase in runtime.

In some embodiments, input data includes relatively static sets of defined data, such as may be found with residential information. In some embodiments, the input data can include at least some of the data being “big data” or data that which is generated on an ongoing basis.

For at least the reasons disclosed, it may be seen that superblocking module 177 results in improved operations in the way computers operate. One or more embodiments of the present disclosure have the technical effect of reducing the computation time used in searching data sets from multiple sources to aggregate common data.

A number of industries can benefit from the technology disclosed herein. Some non-limiting examples are introduced. In healthcare and life sciences, data constructs include genomic sequences, electronic health records (EHR), imaging data, clinical trials, wearable device data and more. Challenges in this sector include heterogeneity, privacy constraints, real-time monitoring, dimensionality of data. In finance and banking, where data constructs include transaction logs, market feeds, risk models, fraud detection data, customer behavior and more. Challenges include high frequency, latency sensitivity, anomaly detection, real-time analytics of data. In e-commerce and retail, where data constructs include purchase history, clickstreams, inventory logs, customer profiles, supply chain data and more. Challenges include personalization, recommendation engines, price optimization, demand forecasting of the data. In telecommunications, data constructs include call data records (CDRs), network traffic, customer support interactions, geolocation data and more. Challenges include time-series complexity, signal vs. noise discrimination, real-time alerting of the data. In energy and utilities, data constructs: include smart meter outputs, grid sensor data, consumption patterns, equipment telemetry, and more. Challenges include spatial-temporal resolution, predictive maintenance, fault localization of the data. In transportation and logistics, data constructs include GPS traces, vehicle telemetry, routing logs, shipment tracking and more. Challenges include real-time optimization, geospatial joins, ETA prediction of the data. In media and entertainment, data constructs include streaming logs, user preferences, content metadata, social media interactions and more. Challenges include recommender systems, content ranking, click-through optimization for the data. In cybersecurity, data constructs include event logs, authentication records, network packets, malware signatures and more. Challenges include detection of rare events, pattern matching at scale, anomaly identification in the data. In scientific research, data constructs include experimental data, simulation results, instrument outputs, observational databases and more. Challenges include multimodal fusion, data provenance, reproducibility, large-scale sorting in HPC environments of the data. In government and public policy, data constructs include census records, policy documents, economic indicators, satellite data and more. Challenges include integration of structured/unstructured data, cross-agency sharing, longitudinal analysis of the data.

Many of the challenges in these segments of industry may be addressed, at least in part, by application of the technologies disclosed herein. Accordingly, task or purpose oriented systems may be provided and include software and/or firmware adapted for addressing the unique challenges posed.

All statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Various other components may be included and called upon for providing for aspects of the teachings herein. For example, additional materials, combinations of materials and/or omission of materials may be used to provide for added embodiments that are within the scope of the teachings herein. Adequacy of any particular element for practice of the teachings herein is to be judged from the perspective of a designer, manufacturer, seller, user, system operator or other similarly interested party, and such limitations are to be perceived according to the standards of the interested party.

In the disclosure hereof any element expressed as a means for performing a specified function is intended to encompass any way of performing that function including, for example, (a) a combination of circuit elements and associated hardware which perform that function or (b) software in any form, including, therefore, firmware, microcode, or the like as set forth herein, combined with appropriate circuitry for executing that software to perform the function. In one or more embodiments, any means which can provide those functionalities can be regarded as equivalent to those shown herein. No functional language used in claims appended herein is to be construed as invoking 35 U.S.C. § 112(f) interpretations as “means-plus-function” language unless specifically expressed as such by use of the words “means for” or “steps for” within the respective claim.

When introducing elements of the present invention or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements. The term “exemplary” is not intended to be construed as a superlative example but merely one of many possible examples.

What is claimed is:

1. A computer implemented method for sorting diverse sets of data, comprising:
receiving a plurality of records from one or more data sources, wherein each record includes one or more attributes associated with an entity;
creating superblocks based upon one or more blocking attributes;
generating k-mers for all the records based upon a selected k value;
performing blocking on the records and placing any records with matching k-mers in the appropriate superblocks;
defining a graph G(V, E) where there is a node per record and connecting records via an edge in the graph when records are found together in at least one of the superblocks and an edit distance between the records is within a given threshold value; and
finding and outputting the connected components of graph G(V, E) as final clusters.

2. The method of claim 1, wherein each record is a string of characters and a record is in multiple blocks.

3. The method of claim 1, wherein the superblocks are defined based upon predefined criteria, the value of some parameter, or some other characteristic of the problem being solved.

4. The method of claim 1, wherein blocking on the records is comprised of a total of sk blocks, where sis the size of the alphabet and k is the selected value for k-mers.

5. The method of claim 1, wherein blocking on the records are adjusted to account for the deletion of the first character in a record when determining whether to add records to a superblock.

6. The method of claim 1, wherein the edit distance can be adjusted so the edit distance between records in the blocking attributes is no more than a selected value.

7. The method of claim 1, wherein the threshold value is calculated using an empirical ground truth error rate for a sample of the records.

8. A non-transitory computer readable medium having program instructions stored thereon for sorting diverse sets of data which, when executed by a processor, causes the processor to carry out the steps of:
receiving a plurality of records from one or more data sources, wherein each record includes one or more attributes associated with an entity;
creating superblocks based upon one or more blocking attributes;
generating k-mers for all the records based upon a selected k value;
performing blocking on the records and placing any records with matching k-mers in the appropriate superblocks;
defining a graph G(V, E) where there is a node per record and connecting records via an edge in the graph if they are found together in at least one of the superblocks and an edit distance between the records is within a given threshold value; and
finding and outputting the connected components of graph G(V, E) as final clusters.

9. The non-transitory computer readable medium of claim 8, wherein the one or more data sources include call data records (CDRs), network traffic, customer support interactions, geolocation data.

10. The non-transitory computer readable medium of claim 8, wherein the one or more data sources include purchase history, clickstreams, inventory logs, customer profiles, supply chain data.

11. The non-transitory computer readable medium of claim 8, wherein the one or more data sources include one or more of data from the Census Bureau, Social Security Administration, hospitals, healthcare providers, traffic data, transactional data, and forensic data.

12. The non-transitory computer readable medium of claim 8, wherein the one or more data sources include financial records, banking records, transaction logs, market feeds, risk models, fraud detection data, customer behavior.

13. The non-transitory computer readable medium of claim 8, wherein at least one of the one or more data sources includes genomic sequences, electronic health records, imaging data, clinical trials, wearable device data.

14. The non-transitory computer readable medium of claim 10, wherein the sorting of diverse sets of data includes a linkage of records and resolution of entities.

15. An apparatus for sorting diverse sets of data, comprising, one or more processors, and memory accessible by the one or more processors, the memory storing instructions that when executed by the one or more processors, cause the apparatus to perform the method of:
receiving a plurality of records from one or more data sources, wherein each record includes one or more attributes associated with an entity;
creating superblocks based upon one or more blocking attributes;
generating k-mers for all the records based upon a selected k value;
performing blocking on the records and placing any records with matching k-mers in the appropriate superblocks;
defining a graph G(V, E) where there is a node per record and connecting records via an edge in the graph if they are found together in at least one of the superblocks and an edit distance between the records is within a given threshold value; and
finding and outputting the connected components of graph G(V, E) as final clusters.

16. The apparatus of claim 15, wherein the one or more data sources includes a combination of structured and unstructured data.

17. The apparatus of claim 15, wherein the one or more data sources includes one or more of smart meter outputs, grid sensor data, consumption patterns, and equipment telemetry.

18. The apparatus of claim 15, wherein the data sources include one or more of streaming logs, user preferences, content metadata, and social media interactions.

19. The apparatus of claim 15 wherein the one or more data sources includes one or more of event logs, authentication records, network packets, malware signatures.

20. The apparatus of claim 15, wherein at least one of the one or more data sources includes biometric data.
